(19) United States
(12) Patent Application Publication
(10) Pub. No.: US 2006/0032500 A1
(43) Pub. Date: Feb. 16, 2006

(54) Connector piece for oxygen mask, oxygen mask and corresponding respiratory monitoring assembly

(76) Inventors: Fabrice Ghiron, Meylan (FR); Jean-Pierre Hercule, Lyon (FR); Jacek Wasylkiewicz, Bron (FR)

Correspondence Address: Ralph A. Dowell of DOWELL & DOWELL P.C., 2111 Eisenhower Ave, Suite 406, Alexandria, VA, 22314, US

(21) Appl. No.: 11/183,183

(22) Filed: Jul. 18, 2005

(30) Foreign Application Priority Data
Jul. 19, 2004 (FR) 0407978

(51) Int. Cl. A62B 9/04

(52) U.S. Cl. 128/202.27

(57) ABSTRACT

The oxygen mask according to the invention comprises a body intended to cover a patient's nose and mouth, as well as a connector piece adapted to be joined to the body, this connector piece comprising means for connection to an oxygen supply pipe. This connector piece also comprises means for evacuating the gas exhaled by the patient, which are adapted to be connected to an apparatus for determining at least one respiratory parameter of the patient.

### FIELD OF THE INVENTION

The present invention relates to a connector piece for an oxygen mask, to an oxygen mask equipped with such a connector piece, and to a respiratory monitoring assembly comprising such a mask.

### BACKGROUND OF THE INVENTION

An oxygen mask is conventionally composed of a supple body, made for example of polyvinyl chloride, or PVC. This body, which covers the patient's mouth and nose when in service, receives a removable connector piece which is joined in particular by cooperation of shapes. This connector piece is provided with an admission pipe, of appropriate shape, for supplying the patient with oxygen.

An oxygen mask of the type described hereinbefore can be employed in numerous circumstances.

It is firstly used in recovery rooms, namely after the patient has undergone a general anaesthetic. It is also possible to employ such a mask in different respiratory pathologies necessitating a supply of oxygen and a respiratory monitoring by capnography. Finally, this oxygen mask is advantageously used in surgical procedures which are carried out under spontaneous ventilation.

It will be readily appreciated that the supply of oxygen via this mask is accompanied by a monitoring of the patient's breathing. This avoids any risk of accident likely to prove dramatic.

In this respect, it is firstly known to monitor the oxygen saturation rate in the blood, for example by an infrared sensor placed at the patient's finger tip. However, this solution does not prove to be sufficiently reactive, in particular in the event of a substantial reduction of the patient's breathing rate.

It is also possible for the nursing staff to carry out this respiratory monitoring themselves. However, this alternative solution is unsatisfactory, in terms of security. Moreover, it requires much relatively qualified manpower.

This being specified, the invention proposes to overcome all the drawbacks of the prior art set forth hereinabove.

### SUMMARY OF THE INVENTION

To that end, it relates to a connector piece for an oxygen mask, adapted to be joined to a body of this mask, this connector piece comprising connection means adapted to be connected to oxygen supply means, characterized in that this connector piece also comprises means for evacuating the gas exhaled by the patient, these evacuation means being adapted to be connected to an apparatus for determining at least one respiratory parameter of the patient.

The invention also relates to an oxygen mask comprising a body intended to cover a patient's nose and mouth, as well as a connector piece adapted to be joined to the body, particularly by fitting, characterized in that the connector piece is as defined hereinabove.

Finally, the invention relates to a respiratory monitoring assembly comprising:

an oxygen mask as defined hereinabove,

oxygen supply means;

means for connection between these oxygen supply means and the connection means belonging to the mask;

means for determining at least one respiratory parameter of the patient; and

means for connection between these determining means and the evacuation means belonging to the mask.

### BRIEF DESCRIPTION OF THE DRAWINGS

The invention will be more readily understood and other advantages thereof will appear more clearly in the light of the following description of a respiratory monitoring assembly in accordance with its principle, given solely by way of non-limiting example and made with reference to the accompanying drawings, in which:

FIG. 1 is a schematic view illustrating a respiratory monitoring assembly in accordance with the invention.

FIG. 2 is a side view, on a larger scale, illustrating a connector piece belonging to an oxygen mask with which the respiratory monitoring assembly of FIG. 1 is equipped; and

FIG. 3 is a front view illustrating the connector piece of FIG. 2.

### DESCRIPTION OF PREFERRED EMBODIMENT

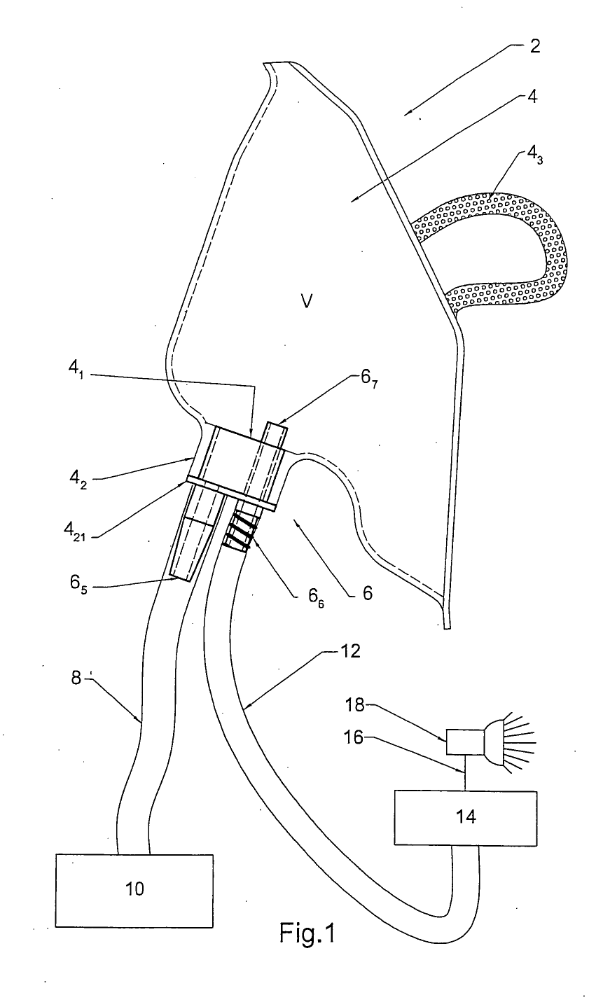

Referring now to the drawings, the respiratory monitoring assembly shown in FIG. 1 firstly comprises an oxygen mask generally designated by reference 2. The latter comprises, in manner known per se, a supple body 4, made in particular of PVC, or polyvinyl chloride. This supple body 4 is intended to cover the patient's nose and mouth when in service.

In its anterior part, with reference to its position when worn, the supple body has an orifice 4₁ made therein, from which a neck 4₂ extends, directed opposite the interior volume V of the mask. As will be seen in greater detail hereinafter, this neck 4₂ is intended to receive a connector piece 6.

Finally, the body 4 is provided with an elastic tie 4₃ adapted to pass around the patient's head, in order to ensure that the mask 2 assembly is held thereon.

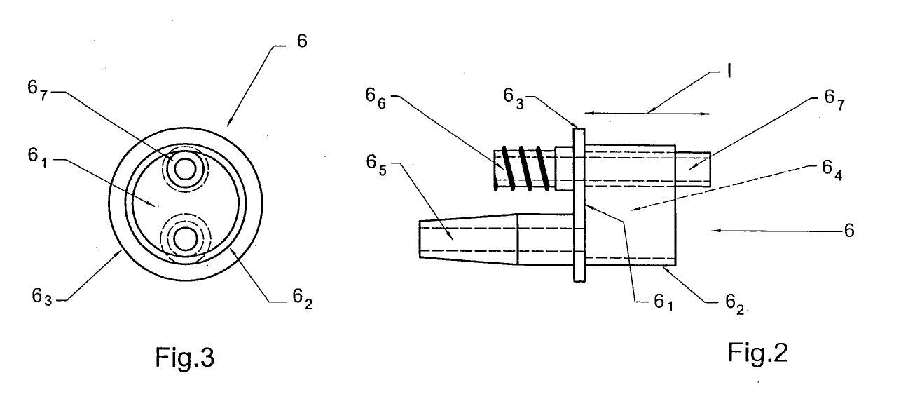

With reference in particular to FIGS. 2 and 3, this connector piece 6 comprises a base 6₁ from which extends a cylindrical shaft 6₂ intended to be fitted in the neck 4₂. This base is also provided with a flange 6₃ intended to abut against the free end 4₂₁ of the neck 4₂, this free end thus forming a seat for the connector piece 6.

Furthermore, it will be noted that the shaft 6₂, whose axial dimensions correspond substantially to those of the neck 4₂, defines a chamber denoted 6₄. On the outside, opposite the volume V, there is provided a conduit 6₅ opening out in this chamber 6₄. This conduit 6₅ is intended to be connected with a line 8, visible in FIG. 1, which is placed in communication with oxygen supply means, denoted 10, which are known as such.

In the vicinity of the conduit 6₅, on the outside of the connector piece, there is also provided a threaded connection 6₆, adapted to cooperate by screwing with a flexible pipe 12. This latter is itself placed in communication with an apparatus 14, of type known per se, which is adapted to determine in real time at least one respiratory parameter of the patient. This apparatus 14 is furthermore connected, by a line 16, to an alarm 18 which is for example of the acoustic type.

Referring in particular to FIG. 2, the threaded connection 6₆ opens out in a tube 6₇ extending from the base 6₁ in the direction of the interior volume V. It should be noted that this tube 6₇ which is adapted to evacuate the gas exhaled by the patient, opens out directly in the connection 6₆, in that it is not placed in communication with the chamber 6₄.

Moreover, as is clearly shown in FIGS. 1 and 2, the evacuation tube 6₇ projects, in the direction of the afore-mentioned interior volume V, both with respect to the shaft 6₂ of the connector piece and with respect to the orifice 4₁ of the supple body 4. The length 1 of the tube 6₇ is advantageously included between 15 and 35 mm, being in particular close to 20 mm.

This configuration of the evacuation tube is advantageous, since it avoids any mixture between the respective flows constituted by the oxygen and the gas exhaled by the patient. By way of variant (not shown), the oxygen supply conduit may be extended by a supply tube, projecting towards the interior volume V, while the evacuation tube is shortened, and even eliminated.

The use of the respiratory monitoring assembly described hereinabove will now be explained.

It is firstly question of conventionally administering oxygen to the patient. This operation is carried out thanks to the supply means 10 which deliver this oxygen towards the interior volume V, via the line 8 and the conduit 6₅.

Concomitantly, the gas exhaled by the patient is conducted towards the analysis apparatus 14, via the evacuation tube 6₇, the connection 6₆ and the flexible pipe 12. This apparatus 14 is in particular provided with a computer adapted to determine, inter alia, the patient's breathing rate, and the carbon dioxide CO₂ content present in the gas exhaled by this patient.

If the instantaneous values thus determined lie outside a predetermined range, the alarm 18 is activated, this allowing the nursing staff to intervene on the patient. By way of non-limiting example, this alarm 18 is activated if the breathing rate descends below 6 per minute and/or if the CO₂ content in the exhaled gas becomes greater than 30%.

The invention enables the objects set forth hereinabove to be attained. In effect, it guarantees a satisfactory monitoring of the patient, in particular insofar as it detects any substantial variations of his/her breathing parameters. Consequently, the risks of accident are substantially eliminated.

Moreover, the invention renders the determination of the patient's breathing parameters extremely precise. In this respect, it is particularly advantageous to arrange on the same connector piece, both the oxygen admission means and the means for evacuating the gas exhaled by the patient.

What is claimed is:

1. Connector piece for an oxygen mask, adapted to be joined to a body of this mask, this connector piece comprising connection means adapted to be connected to oxygen supply means,
wherein this connector piece also comprises means for evacuating the gas exhaled by the patient, these evacuation means being adapted to be connected to an apparatus for determining at least one respiratory parameter of the patient.

2. The connector piece for oxygen mask of claim 1, wherein the connection means and the evacuation means extend from a base of said connector piece, this base being adapted to come into abutment against a seat of the body.

3. The connector piece for oxygen mask of claim 2, wherein the evacuation means comprise an evacuation tube, extending from the base in the direction of an interior volume of the body, as well as an evacuation connection extending from the base opposite said interior volume, this evacuation connection opening directly in the evacuation tube.

4. The connector piece for oxygen mask of claim 3, wherein the connector piece comprises a shaft adapted to abut against walls of a neck of the body, the evacuation tube projecting beyond the shaft, in the direction of the interior volume.

5. The connector piece for oxygen mask of claim 3, wherein the evacuation connection is disposed next to a conduit for connection to said oxygen supply means.

6. The connector piece for oxygen mask of claim 3, wherein the evacuation tube presents an axial dimension, or length, which is included between 15 and 35 mm, in particular close to 20 mm.

7. Oxygen mask comprising a body intended to cover a patient's nose and mouth, as well as a connector piece adapted to be joined to the body, particularly by fitting, wherein the connector piece is in accordance with claim 1.

8. Respiratory monitoring assembly comprising:
an oxygen mask according to claim 7,
oxygen supply means;
means for connection between these oxygen supply means and the connection means belonging to the mask;
means for determining at least one respiratory parameter of the patient; and
means for connection between these determining means and the evacuation means belonging to the mask.

9. The respiratory monitoring assembly of claim 8, wherein it also comprises an alarm adapted to be activated if a value of the or each respiratory parameter determined by the determination means, lies outside a predetermined range.

10. The respiratory monitoring assembly of claim 8, wherein a respiratory parameter is the patient's breathing rate, and/or the amount of carbon dioxide present in the gas exhaled by the patient.
